(19) United States
(12) Patent Application Publication
(10) Pub. No.: US 2006/0184771 A1
(43) Pub. Date: Aug. 17, 2006

(54) Mini-refresh processor recovery as bug workaround method using existing recovery hardware

(75) Inventors: Michael Stephen Floyd, Austin, TX (US); Larry Scott Leitner, Austin, TX (US); Sheldon B. Levenstein, Austin, TX (US); Scott Barnett Swaney, Catskill, NY (US); Brian William Thompto, Austin, TX (US)

Correspondence Address: IBM CORP (YA);C/O YEE & ASSOCIATES PC, P.O. BOX 802333, DALLAS, TX, 75380, US

(73) Assignee: International Business Machines, Armonk, NY (US)

(21) Appl. No.: 11/055,823

(22) Filed: Feb. 11, 2005

(51) Int. Cl. G06F 9/30

(52) U.S. Cl. 712/218

(57) ABSTRACT

A method in a data processing system for avoiding a microprocessor's design defects and recovering a microprocessor from failing due to design defects, the method comprised of the following steps: The method detects and reports of events which warn of an error. Then the method locks a current checkpointed state and prevents instructions not checkpointed from checkpointing. After that, the method releases checkpointed state stores to a L2 cache, and drops stores not checkpointed. Next, the method blocks interrupts until recovery is completed. Then the method disables the power savings states throughout the processor. After that, the method disables an instruction fetch and an instruction dispatch. Next, the method sends a hardware reset signal. Then the method restores selected registers from the current checkpointed state. Next, the method fetches instructions from restored instruction addresses. Then the method resumes a normal execution after a programmable number of instructions.

### CROSS-REFERENCE TO RELATED APPLICATION

The present application is related to co-pending application entitled “PROCESSOR INSTRUCTION RETRY RECOVERY”, Ser. No. ______, attorney docket number AUS920040996US1, filed on even date herewith. The above application is assigned to the same assignee and is incorporated herein by reference.

### BACKGROUND OF THE INVENTION

1. Technical Field

The present invention generally relates to an improved data processing system and, in particular, to a method, apparatus, or computer program product for limiting performance degradation while working around a design defect in a data processing system. Still more particularly, the present invention provides a method, apparatus, or computer program product for enhancing performance of avoiding a microprocessor's design defects and recovering a microprocessor from failing due to a design defect.

2. Description of Related Art

A microprocessor is a silicon chip that contains a central processing unit (CPU) which controls all the other parts of a digital device. Designs vary widely but, in general, the CPU consists of the control unit, the arithmetic and logic unit (ALU) and memory (registers, cache, RAM and ROM) as well as various temporary buffers and other logic. The control unit fetches instructions from memory and decodes them to produce signals which control the other part of the computer. This may cause it to transfer data between memory and ALU or to activate peripherals to perform input or output. A parallel computer has several CPUs which may share other resources such as memory and peripherals. In addition to bandwidth (the number of bits processed in a single instruction) and clock speed (how many instructions per second the microprocessor can execute, microprocessors are classified as being either RISC (reduced instruction set computer) or CISC (complex instruction set computer).

Bugs in the logic design of a microprocessor are often implemented in real hardware where they are then found during prototype testing in a lab or, even worse, in a product in the field. Methods have been employed in the past to work around these bugs when they are found in order to allow the hardware to continue to operate despite the presence of the bug, even if in a reduced performance mode of operation. However, not all bugs are easy to work around, especially if they cannot be detected and preemptively prevented from corrupting the architected state of the machine before evasive action can be taken. Prior machines have “piggybacked” on or used existing or similar hardware mechanisms, such as an instruction flush used to recover the pipeline from a branch mispredict. However, these techniques are not always successful to work around all classes of bugs, and bugs cannot always be detected in time to stop writeback of registers with incorrect data, thus corrupting the architected state.

A more recent advance is the notion of processor instruction retry recovery. This method traditionally is intended to recover from a temporary run-time hardware failure, such as a soft-error. However, in many cases, full processor recovery is also successful in working around a design bug present in the hardware. This is because the architected state is restored, undoing the bad effects of the bug, and caches and translation buffers are invalidated to ensure coherency with the rest of the system is maintained in spite of the hardware bug. This method is often successful in recovering from a design bug because when the instruction stream that exposed the bug re-executes, the instructions are processed differently, either as a side effect of executing a slightly different order, or on purpose when the hardware intentionally throttles back the execution of the processor by engaging a reduced execution mode (such as slowing the dispatch rate) until the bug is avoided. This method is often successful, however is slow because all architected state is restored and measurably hurts performance because the level 1 cache and buffers are empty and must be reloaded from the memory subsystem. If instruction retry recovery was invoked for a frequent (every several seconds) event, the performance penalty could be large enough that the customer would realize measurable performance loss, which is unacceptable for a successful workaround to be employed.

Therefore, it would be advantageous to have an improved method, apparatus, or computer program product for enhancing performance of avoiding a microprocessor's design defects and recovering a microprocessor from failing due to a design defect.

### SUMMARY OF THE INVENTION

The present invention is a method in a data processing system for avoiding a microprocessor's design defects and recovering a microprocessor from failing due to a design defect. The method is comprised of the following steps: The method detects and reports a plurality of events which warn of an error. Then the method locks a current checkpointed state (the last known good execution point in the instruction stream) and prevents a plurality of instructions not checkpointed from checkpointing. After that, the method releases a plurality of checkpointed state stores to a L2 cache, and drops a plurality of stores not checkpointed. Next, the method blocks a plurality of interrupts until recovery is completed. Then the method disables the power savings states throughout the processor. E.g. Forces clocks to idle circuits in a low-power state. After that, the method disables an instruction fetch and an instruction dispatch. Next, the method sends a hardware reset signal. Then the method restores a plurality of selected registers from the current checkpointed state. Next, the method fetches a plurality of instructions from a plurality of restored instruction addresses. Then the method resumes a normal execution after a programmable number of instructions.

One may note the similarity to the instruction retry recovery sequence, but with key differences. Mini-refresh, unlike full recovery, only restores a selected subset of the architected state and does not necessarily invalidate all caches and translation buffers because the coherency with the system has not necessarily been lost. The circuits are presumed functioning properly, and a functional reset is only required for predictably backing up the state of the processor, not for clearing an unpredictable error state from the circuitry. The processor is not necessarily logically removed from a symmetric multi-processing (SMP) system, so incoming invalidates to the processor are still monitored, performed, and responded to. The elements of the reduced performance mode operation are independently selected for the mini-refresh to further optimize (reduce) the performance impact. Finally, thresholding is not done for mini-refresh, and instead forward progress is guaranteed by disabling re-entry to the mini-refresh sequence until after progression beyond reduced execution mode.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a processor system for processing information according to the preferred embodiment;

FIG. 2 is a block diagram of specific components used in a processor system for processing information according to the preferred embodiment;

FIG. 3 is a diagram of the steps required for the mini-refresh in accordance with a preferred embodiment of the present invention; and

FIG. 4 is a diagram of the steps required for one option to address the possibility of broken coherency between the L1 Data cache and the L2 cache, in accordance with a preferred embodiment of the present invention.

### DETAILED DESCRIPTION OF THE PREFERRED EMBODIMENT

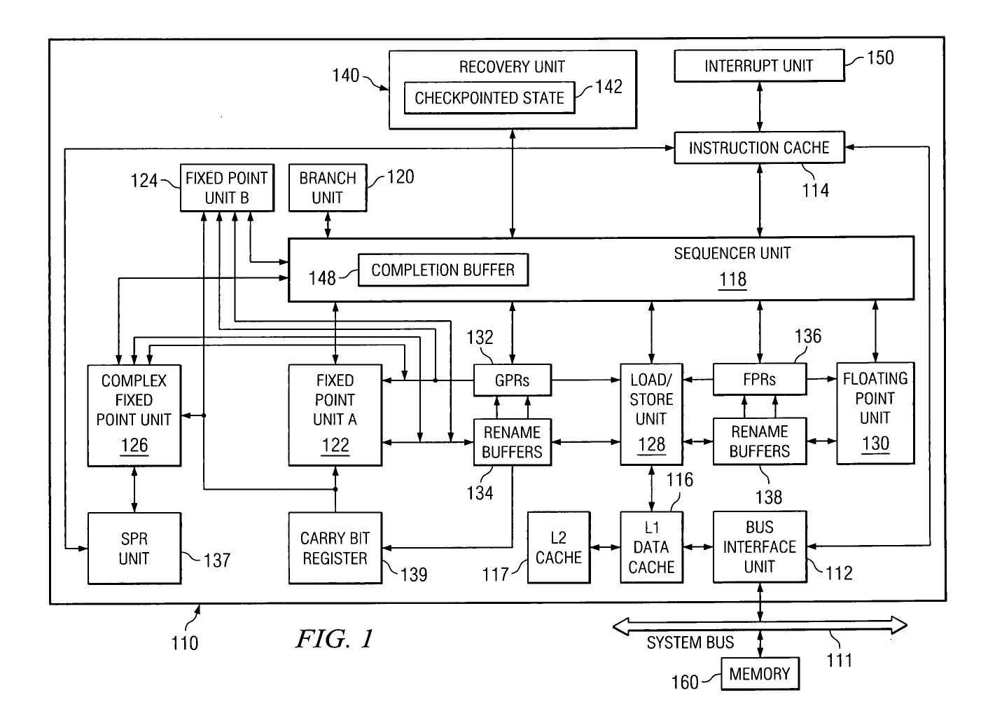

FIG. 1 is a block diagram of a processor 110 system for processing information according to the preferred embodiment. In the preferred embodiment, processor 110 is a single integrated circuit superscalar microprocessor. Accordingly, as discussed further herein below, processor 110 includes various units, registers, buffers, memories, and other sections, all of which are formed by integrated circuitry. Also, in the preferred embodiment, processor 110 operates according to reduced instruction set computer (“RISC”) techniques. As shown in FIG. 1, a system bus 111 is connected to a bus interface unit (“BIU”) 112 of processor 110. BIU 112 controls the transfer of information between processor 110 and system bus 111.

BIU 112 is connected to an instruction cache 114 and to a data cache 116 of processor 110. Instruction cache 114 outputs instructions to a sequencer unit 118. In response to such instructions from instruction cache 114, sequencer unit 118 selectively outputs instructions to other execution circuitry of processor 110.

In addition to sequencer unit 118, in the preferred embodiment, the execution circuitry of processor 110 includes multiple execution units, namely a branch unit 120, a fixed-point unit A (“FXUA”) 122, a fixed-point unit B (“FXUB”) 124, a complex fixed-point unit (“CFXU”) 126, a load/store unit (“LSU”) 128, and a floating-point unit (“FPU”) 130. FXUA 122, FXUB 124, CFXU 126, and LSU 128 input their source operand information from general-purpose architectural registers (“GPRs”) 132 and fixed-point rename buffers 134. Moreover, FXUA 122 and FXUB 124 input a “carry bit” from a carry bit (“CA”) register 139. FXUA 122, FXUB 124, CFXU 126, and LSU 128 output results (destination operand information) of their operations for storage at selected entries in fixed-point rename buffers 134. Also, CFXU 126 inputs and outputs source operand information and destination operand information to and from special-purpose register processing unit (“SPR unit”) 137.

FPU 130 inputs its source operand information from floating-point architectural registers (“FPRs”) 136 and floating-point rename buffers 138. FPU 130 outputs results (destination operand information) of its operation for storage at selected entries in floating-point rename buffers 138.

In response to a Load instruction, LSU 128 inputs information from data cache 116 and copies such information to selected ones of rename buffers 134 and 138. If such information is not stored in data cache 116, then data cache 116 inputs (through BIU 112 and system bus 111) such information from a system memory 160 connected to system bus 111. Moreover, data cache 116 is able to output (through BIU 112 and system bus 111) information from data cache 116 to system memory 160 connected to system bus 111. In response to a Store instruction, LSU 128 inputs information from a selected one of GPRs 132 and FPRs 136 and copies such information to data cache 116.

Sequencer unit 118 inputs and outputs information to and from GPRs 132 and FPRs 136. From sequencer unit 118, branch unit 120 inputs instructions and signals indicating a present state of processor 110. In response to such instructions and signals, branch unit 120 outputs (to sequencer unit 118) signals indicating suitable memory addresses storing a sequence of instructions for execution by processor 110. In response to such signals from branch unit 120, sequencer unit 118 inputs the indicated sequence of instructions from instruction cache 114. If one or more of the sequence of instructions is not stored in instruction cache 114, then instruction cache 114 inputs (through BIU 112 and system bus 111) such instructions from system memory 160 connected to system bus 111.

In response to the instructions input from instruction cache 114, sequencer unit 118 selectively dispatches the instructions to selected ones of execution units 120, 122, 124, 126, 128, and 130. Each execution unit executes one or more instructions of a particular class of instructions. For example, FXUA 122 and FXUB 124 execute a first class of fixed-point mathematical operations on source operands, such as addition, subtraction, ANDing, ORing and XORing. CFXU 126 executes a second class of fixed-point operations on source operands, such as fixed-point multiplication and division. FPU 130 executes floating-point operations on source operands, such as floating-point multiplication and division.

As information is stored at a selected one of rename buffers 134, such information is associated with a storage location (e.g., one of GPRs 132 or CA register 139) as specified by the instruction for which the selected rename buffer is allocated. Information stored at a selected one of rename buffers 134 is copied to its associated one of GPRs 132 (or CA register 139) in response to signals from sequencer unit 118. Sequencer unit 118 directs such copying of information stored at a selected one of rename buffers 134 in response to “completing” the instruction that generated the information. Such copying is called “writeback.”

As information is stored at a selected one of rename buffers 138, such information is associated with one of FPRs 136. Information stored at a selected one of rename buffers 138 is copied to its associated one of FPRs 136 in response to signals from sequencer unit 118. Sequencer unit 118 directs such copying of information stored at a selected one of rename buffers 138 in response to “completing” the instruction that generated the information.

Processor 110 achieves high performance by processing multiple instructions simultaneously at various ones of execution units 120, 122, 124, 126, 128, and 130. Accordingly, each instruction is processed as a sequence of stages, each being executable in parallel with stages of other instructions. Such a technique is called “pipelining.” In a significant aspect of the illustrative embodiment, an instruction is normally processed as six stages, namely fetch, decode, dispatch, execute, completion, and writeback.

In the fetch stage, sequencer unit 118 selectively inputs (from instruction cache 114) one or more instructions from one or more memory addresses storing the sequence of instructions discussed further hereinabove in connection with branch unit 120, and sequencer unit 118.

In the decode stage, sequencer unit 118 decodes up to four fetched instructions.

In the dispatch stage, sequencer unit 118 selectively dispatches up to four decoded instructions to selected (in response to the decoding in the decode stage) ones of execution units 120, 122, 124, 126, 128, and 130 after reserving rename buffer entries for the dispatched instructions' results (destination operand information). In the dispatch stage, operand information is supplied to the selected execution units for dispatched instructions. Processor 110 dispatches instructions in order of their programmed sequence.

In the execute stage, execution units execute their dispatched instructions and output results (destination operand information) of their operations for storage at selected entries in rename buffers 134 and rename buffers 138 as discussed further hereinabove. In this manner, processor 110 is able to execute instructions out-of-order relative to their programmed sequence.

In the completion stage, sequencer unit 118 indicates an instruction is “complete.” Processor 110 “completes” instructions in order of their programmed sequence.

In the writeback stage, sequencer 118 directs the copying of information from rename buffers 134 and 138 to GPRs 132 and FPRs 136, respectively. Sequencer unit 118 directs such copying of information stored at a selected rename buffer. Likewise, in the writeback stage of a particular instruction, processor 110 updates its architectural states in response to the particular instruction. Processor 110 processes the respective “writeback” stages of instructions in order of their programmed sequence. Processor 110 advantageously merges an instruction's completion stage and writeback stage in specified situations.

In the illustrative embodiment, each instruction requires one machine cycle to complete each of the stages of instruction processing. Nevertheless, some instructions (e.g., complex fixed-point instructions executed by CFXU 126) may require more than one cycle. Accordingly, a variable delay may occur between a particular instruction's execution and completion stages in response to the variation in time required for completion of preceding instructions.

A completion buffer 148 is provided within sequencer unit 118 to track the completion of the multiple instructions which are being executed within the execution units. Upon an indication that an instruction or a group of instructions have been completed successfully, in an application specified sequential order, completion buffer 148 may be utilized to initiate the transfer of the results of those completed instructions to the associated general-purpose registers.

Additionally, processor 110 also includes interrupt unit 150, which is connected to instruction cache 114. Additionally, although not shown in FIG. 1, interrupt unit 150 is connected to other functional units within processor 110. Interrupt unit 150 may receive signals from other functional units and initiate an action, such as starting an error handling or trap process. In these examples, interrupt unit 150 is employed to generate interrupts and exceptions that may occur during execution of a program.

A more robust method is desired to recover processor 110 from failing due to a logic bug in the design that has less performance impact than a full processor recovery. One method of recovery is to use a recovery unit 140 added to the microprocessor core design, as shown in FIG. 1, for the purpose of recovering from soft errors caused by technology problems or Alpha particles via processor instruction retry recovery.

The normal processor recovery mechanism must assume the arrays (Static Random Access Memory—SRAM) such as instruction cache 114, L1 data cache 116, or translation buffers (not shown) are in an invalid state because the error may have occurred in or propagated into such arrays. However, most logic design bugs do not manifest themselves as corruption into the SRAMs, but rather cause incorrect processing of the instruction stream itself, processed in sequencer unit 118, which usually results in corruption of the architected state, such as GPRs 132, FPRs 136, and SPRs 137.

This invention uses existing processor recovery unit 140 to restore the “checkpointed”—previously known good and protected—architected state 142 after the detection that a logic bug has been, or may be encountered. Selectable portions or all of the processor architected register state can then be “quickly” restored from the checkpointed state 142 without having to wait on SRAMs to be cleared or initialized, which happens during “normal” processor instruction retry recovery. Thus, the performance impact of the restore and reset is greatly reduced.

Most importantly, not clearing the caches avoids the performance impact due to cache priming effects from invalidating the cache.

After restoring the checkpointed state 142, processor 110 temporarily goes into a “safe mode” to prevent the same code stream scenario in sequencer unit 118 from causing the logic bug to be repeatedly exposed, because repeated exposure of the same code stream scenario could prevent forward progress from occurring. This “safe mode” of execution processes instructions in sequencer unit 118 in a reduced performance mode until a programmable (e.g., 128) number of instructions have been checkpointed; indicating processor 110 has made it safely past the problem code stream.

Processor 110 supports simultaneous multi-threading (SMT) which is the processing of multiple (e.g. two) independent instruction streams at the same time, while maintaining separate architected register state for each thread. Processor 110 may also be attached via system bus 111 to many other such processors in a large, scaleable, symmetric multi-processor (SMP), capable of executing multiple independent (logically partitioned) operating systems. The control of the logical partitioning is provided by a firmware layer called a “hypervisor”, which has privileged access to some of the special-purpose registers within each processor. When the hypervisor firmware layer is executing, the processor is said to be in hypervisor mode, and this special privileged state is identified by a hypervisor bit (HV) in a machine state register (MSR). Interrupts and exception conditions are also handled by the hypervisor firmware.

The “safe mode” of operation is also executed based on Hypervisor state because the original problem or condition may have occurred in non-hypervisor mode, but a pending interrupt could cause immediate entry to hypervisor mode after backing up to the checkpoint state. Care must be taken to ensure processing does not later resume to the original non-hypervisor code stream in sequencer unit 118 and simply encounter the original condition again.

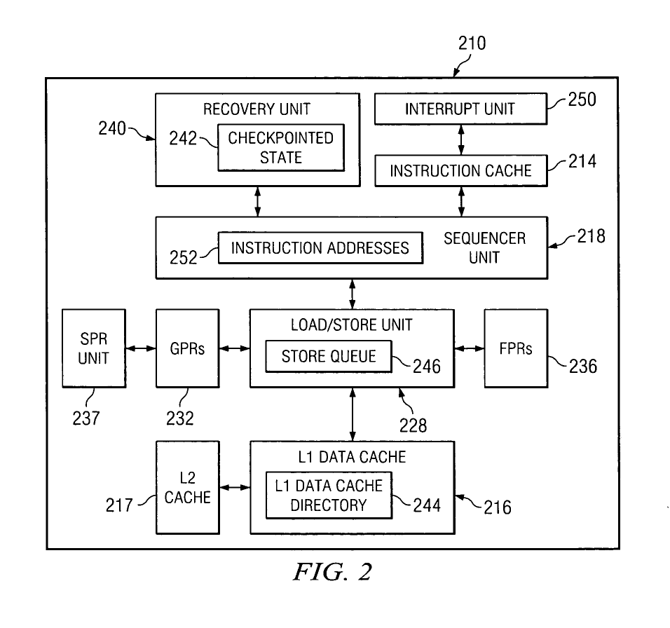

FIG. 2 is a block diagram of specific components used in a processor system for processing information according to the preferred embodiment, for enhancing performance of recovering a microprocessor from failing. The depicted processor 210 components used most frequently by the present invention include checkpointed state 242 in recovery unit 240, instruction addresses 252 in sequencer unit 218, store queue 246 in load/store unit 228, selected registers, such as GPRs 232, FPRs 236, and SPRs 237, interrupt unit 250, and the caches, such as instruction cache 214, L1 data cache 216, L2 cache 217, and L1 data cache directory 244.

The store queue 246 in the load/store unit 228 is a queue of store instructions that are waiting to be transferred to the L2 cache 217. The L1 data cache directory 244 is a directory that contains the partial addresses and valid bits corresponding to the data entries in L1 data cache 216. L1 data cache 216 is a “store-through” cache, meaning that store data written to the L1 is also written to L2 cache 217 at about the same time, so that any modified data in L1 cache 216 is also available in L2 cache 217. L1 cache 216 is dedicated to the processor, whereas L2 cache 217 is shared coherently across all processors in an SMP system.

Because data in L2 cache 217 is shared across all processors in the system, updates to L2 cache 217 must be held up until the store instructions which caused the updates have reached the checkpointed state. However, it is advantageous for performance to allow L1 cache 216 to be written “speculatively” (e.g. in anticipation of the store instruction reaching the checkpointed state) so that results are available to be accessed by subsequent load instructions as early as possible. However, speculatively updating L1 cache 216 creates the condition where a mini-refresh may back up to a checkpointed state prior to a store instruction which caused the update to L1 cache 216, thus L1 cache 216 contains incorrect, or “corrupted” data.

The preferred embodiment of the mini-refresh sequence implements a selection of one of three ways to deal with this situation: 1) Delay all updates to L1 cache 216 until the corresponding store instructions reach the checkpoint state, and update L1 cache 216 at the same time the data is released to L2 cache 217; 2) Invalidate the entire L1 cache 216; 3) Selectively invalidate only the entries from L1 cache 216 which were speculatively updated for store instructions which did not yet reach the checkpoint state. Option 3 is the preferred solution, because option 1 delays all store data from being available in L1 cache 216, and option 2 incurs the penalty mentioned earlier of “priming” the contents of the L1 cache when processing is resumed from the checkpoint.

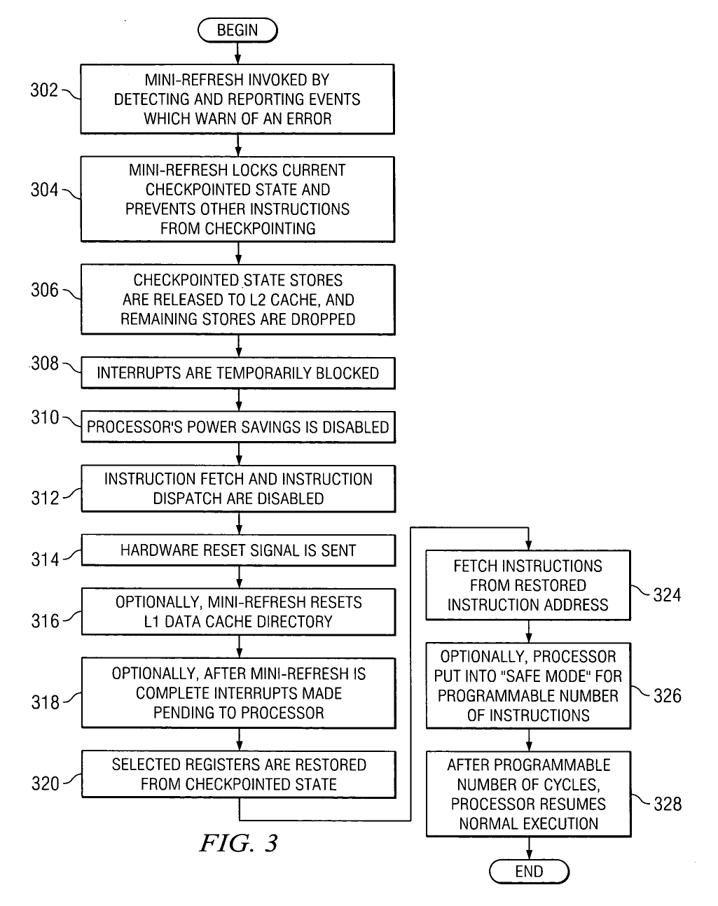

FIG. 3 depicts the steps required for the invention's mini-refresh for enhancing performance of recovering a microprocessor from failing. These steps of the present invention can be implemented using specific components of a processor system, such as those depicted in FIG. 2, including checkpointed state 242 in recovery unit 240 and the caches, such as L1 data cache 216, L2 cache 217, and L1 data cache directory 244.

The mini-refresh is invoked through an inter-unit trigger bus by the detecting and reporting of a programmable set and sequence of events which warn of an error (step 302). The triggers can be programmed to look for the particular workaround scenario. These triggers can be direct or can be event sequences such as A happened before B, or slightly more complex, such as A happened within three cycles of B. Depending on the nature of the design bug, the triggers may be selected to detect that the bug just occurred, or may be about to occur. Once invoked, mini-refresh uses a subset of the processor instruction retry recovery sequence.

Mini-refresh locks the current checkpointed state and prevents any other instructions from checkpointing (step 304). All of the checkpointed state stores that in this implementation reside in the store queue, such as store queue 246 in FIG. 2, are released to the L2 cache, such as L2 cache 217 in FIG. 2, and the rest of the stores are dropped (step 306). Interrupts are temporarily cancelled or blocked in the interrupt unit, such as interrupt unit 250 in FIG. 2 (step 308). Power saving logic is overridden to ensure clocks are provided to all circuitry on the processor (step 310). Instruction fetch and instruction dispatch are disabled in sequencer unit, such as sequencer unit 218 in FIG. 2 (step 312). A hardware reset signal is sent to any logic that needs to be reset to an idle state or logic which must be reset to perform the refresh function (step 314). Mini-refresh can optionally reset the L1 data cache directory, such as L1 data cache directory 244 in FIG. 2, (step 316) to invalidate the entire L1 data cache, such as L1 data cache 216 in FIG. 2. Logic which monitors for and processes incoming invalidates remains active (e.g. not reset) to keep the L1 caches and translation buffers synchronized in a symmetric multi-processing (SMP) system. This logic also supports the option of not invalidating the L1 data cache.

At this point, optionally a selectable Hypervisor Maintenance Interrupt (HMI) to the processor (hypervisor firmware) or a special attention interrupt to the service processor (out-of-band firmware) can be made pending in the interrupt unit (step 318). If a special attention to the service processor is selected, the sequence pauses at step 318 to allow immediate handling by the service processor. For example, if a particular latch value needed to be overridden, the service processor could potentially “fix” it through low-level LSSD scanning. A HMI may be made pending to indicate state which is backed by software instead of hardware (e.g. the Segment Lookaside Buffer) was modified after the checkpoint, so must be restored by software when instruction processing resumes.

Next, selectable architected registers, such as GPRs 232, FPRs 236, and SPRs 237, as shown in FIG. 2, are then restored from the checkpointed state in the recovery unit to the units where the state resides (step 320). A sequencer, such as sequencer unit 218 from FIG. 2, accesses values from the recovery unit, such as recovery unit 240 in FIG. 2, and writes to the appropriate register using the normal writeback paths. This refresh from checkpointed state restores any architected register state that may have already been, or were potentially about to be “corrupted” by the design bug.

The fetch unit will then fetch from the restored instruction addresses, such as instruction addresses 252 in FIG. 2, in the Sequencer unit (step 324). If a HMI was made pending in step 318, instruction processing may first start with the interrupt handler in hypervisor mode prior to resuming to the restored checkpoint if the checkpoint was not already in hypervisor mode. Processing will resume from the checkpoint after the hypervisor maintenance interrupt is handled.

Upon restarting, the processor can be optionally put into a “safe mode” to execute a programmable number of instructions in a programmable reduced execution mode (step 326) in an attempt to avoid the design bug detected or warned by the inter-unit trigger. The trigger, or “warning” condition may or may not still be detected during re-execution of the program sequence in reduced performance mode, but re-entry to the beginning of the mini-refresh sequence is disabled when already in reduced performance mode. This “safe mode” consists of different methods of altering the instruction flow in the sequencer unit, such as serialize issue, serialize dispatch, single thread dispatch, force one instruction per group, stop pre-fetching, serialize floating point, etc.

After the programmable number of instructions reaches the checkpointed state, the processor resumes normal execution (step 328). This is similar to a regular instruction retry recovery, but the parameters for the reduced performance mode are separately programmable to minimize the amount and duration of performance degradation for the known situation identified by the trigger. The parameters for the reduced performance “safe” mode are selected by configuration latches which are setup at processor initialization time.

At this point the sequence is considered completed, and the presence of another intra-unit trigger will invoke the sequence again from the beginning. Any errors detected during the mini-refresh sequence will abort the sequence and invoke normal processor instruction retry recovery.

As mentioned above, there is a possibility that stores may have been “speculatively” written into the L1 data cache. These stores will not be sent to the L2 cache because it would break coherency with a write-through cache structure. As an alternative to invalidating the entire L1 data cache as in step 316, the first solution is to prevent this from happening by delaying all writes to the L1 until the corresponding store instructions reach the checkpoint. This mode is selected by a configuration latch which is set during processor initialization.

Waiting for store instructions to reach the checkpoint before updating the L1 cache obviously incurs a performance penalty due to an effectively deeper store pipeline. With aggressive operating frequencies, the time of flight for signals between the checkpoint controls in the recovery unit and the store queue in the LSU may be multiple cycles. Thus, determining whether store data in the store queue has checkpointed may take more than one machine cycle, which incurs the additional performance penalty of not being able to pipeline writes to the L1 cache every cycle. Although perhaps still useful in a bring-up lab environment, because this mode of operation penalizes performance for all stores, regardless of whether any inter-unit triggers are reported to invoke the mini-refresh sequence, this is unlikely to be tolerable in a real product environment.

Another alternative to purging the entire L1 data cache as in step 316, without incurring the performance penalty of delaying all L1 cache updates is to selectively invalidate only L1 cache entries which were speculatively updated beyond the checkpoint.

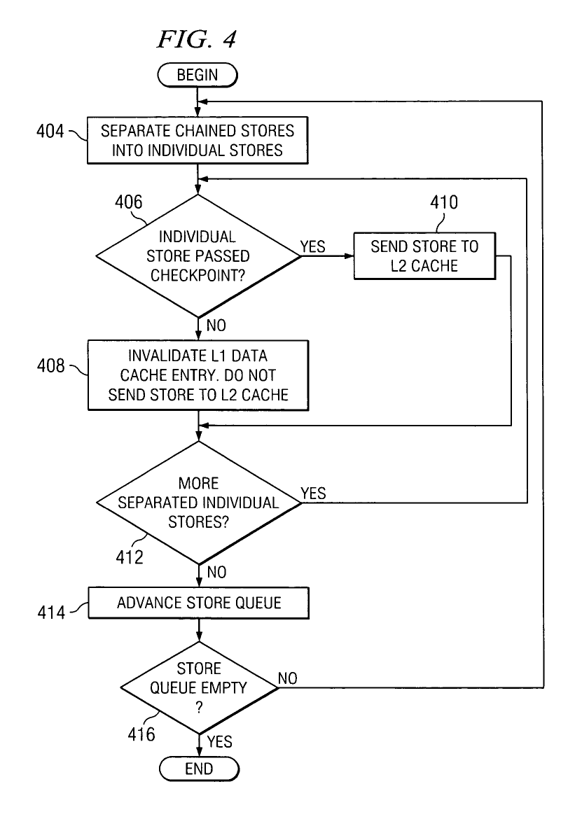

FIG. 4 depicts the steps for selectively purging only the L1 cache entries which were speculatively updated beyond the checkpoint in order to enhance performance of recovering a microprocessor from failing. The sequence depicted by FIG. 4 is actually processed within step 306 from FIG. 3 when enabled by a configuration latch set at processor initialization time. These steps of the present invention can be implemented using specific components of a processor system, such as those depicted in FIG. 2, including store queue 246 in load/store unit 228, checkpointed state 242 in recovery unit 240, and the caches, such as L1 data cache 216, L2 cache 217, and L1 data cache directory 244.

The store queue (246 from FIG. 2) maintains an instruction tag for each entry which is used to identify whether the corresponding instruction was checkpointed or not. In order to reduce the required number of entries in the store queue and the number of separate store commands to the L2 cache, two different stores to the same line can be “chained” together and share a store queue entry. Therefore an instruction tag must be kept for both stores when chained together in the same queue entry.

After a mini-refresh trigger is presented (step 302 from FIG. 3) and the checkpoint locked (step 304 from FIG. 3), the recovery unit signals the LSU to drain completed stores to the L2 cache and drop stores which have not checkpointed yet (step 306 from FIG. 3), which begins the sequence of FIG. 4. The store queue in the LSU is then processed one entry at a time. Chained stores are separated into separate individual stores (step 404) and the older of the separate stores then processed first. If the individual store has already passed the checkpoint (yes branch from decision step 406) then the store is sent to the L2 cache (step 410). If the individual store has not yet passed the checkpoint (no branch from decision step 406) then the L1 data cache entry corresponding to the store address is invalidated and the store is not sent to the L2 cache (step 408). Remaining individual stores separated from a chained store (yes branch of decision step 412) are processed in the same manner returning to decision step 406. If no more individual stores remain for a store queue entry (no branch of decision step 412) then the store queue is advanced to the next entry (step 414). If the store queue is empty (yes branch of decision step 416) the sequence ends. Otherwise (no branch of decision step 416) then the sequence is started from the beginning (step 404) for the next entry.

Note that all store queue entries must continue to be processed even once entries are encountered where the stores have not yet passed the checkpoint. Because multiple processing threads share the store queue, it is possible that checkpointed stores from one thread are “behind” non-checkpointed stores from another thread. Also, the separated individual stores of a chained store entry may span a checkpoint boundary, and also span stores from other queue entries. The LSU indicates to the mini-refresh sequencing logic that all entries have been processed from the store queue according to FIG. 4, so the sequence in FIG. 3 advances to step 308.

The present invention provides a more robust method to recover the processor from failing due to a logic bug in the design, a recovery that has less performance impact than a full processor instruction retry recovery. The present invention also provides two options to address the possibility of broken coherency between the L1 Data cache and the L2 cache which avoid the need to invalidate the entire L1 data cache.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for recovering a processor from failing, the method comprising of steps:
detecting and reporting a plurality of events through programmable triggers which warn of an error;
locking a current checkpointed state and preventing a plurality of instructions not checkpointed from checkpointing;
releasing a plurality of checkpointed state stores to a L2 cache, and dropping a plurality of stores not checkpointed;
blocking a plurality of interrupts until recovery is completed;
disabling a power savings;
disabling an instruction fetch and an instruction dispatch;
sending a hardware reset signal;
restoring a plurality of selectable registers from the current checkpointed state;
fetching a plurality of instructions from a plurality of restored instruction addresses;
resuming a normal execution after a programmable number of instructions.

2. The method of claim 1 further comprising:
responsive to sending a hardware reset signal;
resetting a L1 data cache.

3. The method of claim 1 further comprising:
responsive to sending a hardware reset signal;
pending a plurality of selectable interrupts.

4. The method of claim 1 further comprising:
responsive to fetching a plurality of instructions from a plurality of restored instruction address;
executing a plurality of instructions in a programmable reduced execution mode.

5. The method of claim 1, further comprising:
delaying a plurality of L1 Data cache writes by a plurality processor clocks.

6. The method of claim 1, further comprising the steps:
separating a plurality of chained stores into a plurality of individual stores;
checking if an individual store has passed a checkpoint;
sending the individual store to the L2 cache if the individual store has passed the checkpoint;
invalidating a L1 data cache entry corresponding to an individual store's store address if the individual store has not yet passed the checkpoint;
looping to the checking step if a plurality of individual stores separated from a plurality of chain stores remain;
advancing a store queue to a next entry if a plurality of individual stores separated from a plurality of chain stores does not remain;
looping to the separate step if the store queue is not empty;
ending a sequence of steps if the store queue is empty.

7. A data processing system for recovering a processor from failing, the data processing system comprising:
detecting and reporting means for detecting and reporting a plurality of events through programmable triggers which warn of an error;
locking and preventing means for locking a current checkpointed state and preventing a plurality of instructions not checkpointed from checkpointing;
releasing and dropping means for releasing a plurality of checkpointed state stores to a L2 cache, and dropping a plurality of stores not checkpointed;
blocking means for blocking a plurality of interrupts until recovery is completed;
disabling means for disabling a power savings;
disabling means for disabling an instruction fetch and an instruction dispatch;
sending means for sending a hardware reset signal;
restoring means for restoring a plurality of selectable registers from the current checkpointed state;
fetching means for fetching a plurality of instructions from a plurality of restored instruction addresses;
resuming means for resuming a normal execution after a programmable number of instructions.

8. The data processing system of claim 7 further comprising:
responsive to sending a hardware reset signal;
resetting means for resetting a L1 data cache.

9. The data processing system of claim 7 further comprising:
responsive to sending a hardware reset signal;
pending means for pending a plurality of selectable interrupts.

10. The data processing system of claim 7 further comprising:
responsive to fetching a plurality of instructions from a plurality of restored instruction address;
executing means for executing a plurality of instructions in a programmable reduced execution mode.

11. The data processing system of claim 7, further comprising:
delaying means for delaying a plurality of L1 Data cache writes by a plurality processor clocks.

12. The data processing system of claim 7, further comprising:
separating means for separating a plurality of chained stores into a plurality of individual stores;
checking means for checking if an individual store has passed a checkpoint;
sending means for sending the individual store to the L2 cache if the individual store has passed the checkpoint;
invalidating means for invalidating a L1 data cache entry corresponding to an individual store's store address if the individual store has not yet passed the checkpoint;
looping means for looping to the checking step if a plurality of individual stores separated from a plurality of chain stores remain;
advancing means for advancing a store queue to a next entry if a plurality of individual stores separated from a plurality of chain stores do not remain;
looping means for looping to the separate step if the store queue is not empty;
ending means for ending a sequence of steps if the store queue is empty.

13. A computer program product on a computer-readable medium for use in a data processing system for recovering a processor from failing, the computer program product comprising:
first instructions for detecting and reporting a plurality of events through programmable triggers which warn of an error;
second instructions for locking a current checkpointed state and preventing a plurality of instructions not checkpointed from checkpointing;
third instructions for releasing a plurality of checkpointed state stores to a L2 cache, and dropping a plurality of stores not checkpointed;
fourth instructions for blocking a plurality of interrupts until recovery is completed;
fifth instructions for disabling a power savings;
sixth instructions for disabling an instruction fetch and an instruction dispatch;
seventh instructions for sending a hardware reset signal;
eight instructions for restoring a plurality of selectable registers from the current checkpointed state;
ninth instructions for fetching a plurality of instructions from a plurality of restored instruction addresses;
tenth instructions for resuming a normal execution after a programmable number of instructions.

14. The computer program product of claim 13 further comprising:
responsive to sending a hardware reset signal;
eleventh instructions for resetting a L1 data cache.

15. The computer program product of claim 13 further comprising:
responsive to sending a hardware reset signal;
eleventh instructions for pending a plurality of selectable interrupts.

16. The computer program product of claim 13 further comprising:
responsive to fetching a plurality of instructions from a plurality of restored instruction address;
eleventh instructions for executing a plurality of instructions in a programmable reduced execution mode.

17. The computer program product of claim 13, further comprising:
eleventh instructions for delaying a plurality of L1 Data cache writes by a plurality processor clocks.

18. The computer program product of claim 13, further comprising:
eleventh instructions for separating a plurality of chained stores into a plurality of individual stores;
twelfth instructions for checking if an individual store has passed a checkpoint;
thirteen instructions for sending the individual store to the L2 cache if the individual store has passed the checkpoint;
fourteenth instructions for invalidating a L1 data cache entry corresponding to an individual store's store address if the individual store has not yet passed the checkpoint;
fifteenth instructions for looping to the checking step if a plurality of individual stores separated from a plurality of chain stores remain;
sixteenth instructions for advancing a store queue to a next entry if a plurality of individual stores separated from a plurality of chain stores do not remain;
seventeenth instructions for looping to the separate step if the store queue is not empty;
eighteenth instructions for ending a sequence of steps if the store queue is empty.

19. The method of claim 1 further comprising:
responsive to detecting and reporting a plurality of events through programmable triggers which warn of an error; blocking subsequent reporting until resuming a normal execution after a programmable number of instructions.

20. The data processing system of claim 7 further comprising:
responsive to detecting and reporting a plurality of events through programmable triggers which warn of an error; blocking means for blocking subsequent reporting until resuming a normal execution after a programmable number of instructions.
